(19) United States
(12) Patent Application Publication
(10) Pub. No.: US 2026/0072863 A1
(43) Pub. Date: Mar. 12, 2026

(54) Dynamic Lane Allocation On Power Limited, Dual Port PCIe Device

(71) Applicant: Sandisk Technologies, Inc., Milpitas, CA (US)

(72) Inventors: Amir SEGEV, Meiter (IL); Shay BENISTY, Beer Sheva (IL)

(73) Assignee: Sandisk Technologies, Inc., Milpitas, CA (US)

(21) Appl. No.: 18/829,622

(22) Filed: Sep. 10, 2024

(51) Int. Cl. G06F 13/42

(52) U.S. Cl. CPC G06F 13/4221; G06F 2213/0026

(57) ABSTRACT

Rather than having more lanes than the bus can support, the number of lanes can match the number of lanes the bus can support. For a six lane, two port system that means each port will have two permanent lanes and two lanes that are shared with the other port. When changing configurations from four lanes on the first port to four lanes on the second port, the shared lanes are placed in low power stage from the perspective of the first port and moved into full operational stage for the second port. Thus, each port believes there are four lanes for the port for a total of eight lanes for the device. However, in reality there are only six total lanes for the device, thus saving costs and matching bandwidth and power limitations of the device.

### BACKGROUND OF THE DISCLOSURE

### Field of the Disclosure

Embodiments of the present disclosure generally relate to effective utilization of a multiport system.

### Description of the Related Art

Some nonvolatile memory (NVM) express (NVMe) devices support two peripheral component interconnect (PCI) express (PCIe) ports. Each port has one or more lanes. Each lane consumes a certain amount of power and area (i.e., cost), and provides a given amount of bandwidth. For a six lane, two port device, there are several configurations possible.

One configuration is to have the first port with four lanes and the second port with two lanes. The other option is to have the first port with two lanes and the second port with four lanes. While the device may support six lanes, the data storage device has two options.

The first option is to have eight lanes total, four at each port, and activate only six lanes at any given time. Such an option is a waste of area and money. Another option is to have one four lane port and one six lane port. In that option, the port with six lanes will need to drop a link and reconnect when a new configuration occurs. Such an option is a waste of bandwidth. Thus, there are significant inefficiencies in multiport systems.

Therefore, there is a need in the art for improving efficiencies in multiport systems.

### SUMMARY OF THE DISCLOSURE

Rather than having more lanes than the bus can support, the number of lanes can match the number of lanes the bus can support. For a six lane, two port system that means each port will have two permanent lanes and two lanes that are shared with the other port. When changing configurations from four lanes on the first port to four lanes on the second port, the shared lanes are placed in low power stage from the perspective of the first port and moved into full operational stage for the second port. Thus, each port believes there are four lanes for the port for a total of eight lanes for the device. However, in reality there are only six total lanes for the device, thus saving costs and matching bandwidth and power limitations of the device.

In one embodiment, a data storage device comprises: a memory device; and a controller coupled to the memory device, wherein the controller is configured to: request to move one or more first lanes of a first MAC from a low power state to a full operational state; request to move one or more second lanes of a second MAC from the full operational state to the low power state, wherein the second MAC is distinct from the first MAC; move the one or more second lanes of the second MAC to the low power state; and move the one or more first lanes of the first MAC to the full operational state, wherein the one or more first lanes and the one or more second lanes are the same lanes.

In another embodiment, a data storage device comprises: a memory device; and a controller coupled to the memory device, wherein the controller is configured to: manage a plurality lane connections between a plurality of MACs and a plurality of host devices, wherein one or more first lane connections of the plurality of lane connections are present for a first MAC of the plurality of MACs, wherein one or more second lane connections of the plurality of lane connections are present for a second MAC of the plurality of MACS, and wherein one or more third lanes connections of the plurality of lane connections are shared by the first MAC and the second MAC; cause the first MAC to register the one or more third lane connections as being in a low power state; and cause the second MAC to register the one or more third lane connections as being in a full operational state, wherein the first MAC registers the one or more third lane connections as being in the low power state simultaneous with the second MAC registering the one or more third lane connections as being in the full operational state.

In another embodiment, a data storage device comprises: means to store data; and a controller coupled to the means to store data, wherein the controller is configured to: maintain a PHY having a first plurality of lanes: maintain a first MAC that has a second plurality of lanes, wherein the first plurality is greater than the second plurality; maintain a second MAC that has a third plurality of lanes, wherein the first plurality is greater than the third plurality; and switch between a low power state and a full operational state for lanes shared by the first MAC and the second MAC.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is schematic illustration of a twelve lane system according to one embodiment.

FIG. 3 is schematic illustration of a four lane system according to one embodiment.

FIG. 4 is schematic illustration of a six lane system according to one embodiment.

FIG. 5 is a flowchart illustrating switching from a first six lane configuration to a second six lane configuration.

FIG. 6 is schematic illustration of a multiport system according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Rather than having more lanes than the bus can support, the number of lanes can match the number of lanes the bus can support. For a six lane, two port system that means each port will have two permanent lanes and two lanes that are shared with the other port. When changing configurations from four lanes on the first port to four lanes on the second port, the shared lanes are placed in low power stage from the perspective of the first port and moved into full operational stage for the second port. Thus, each port believes there are four lanes for the port for a total of eight lanes for the device. However, in reality there are only six total lanes for the device, thus saving costs and matching bandwidth and power limitations of the device.

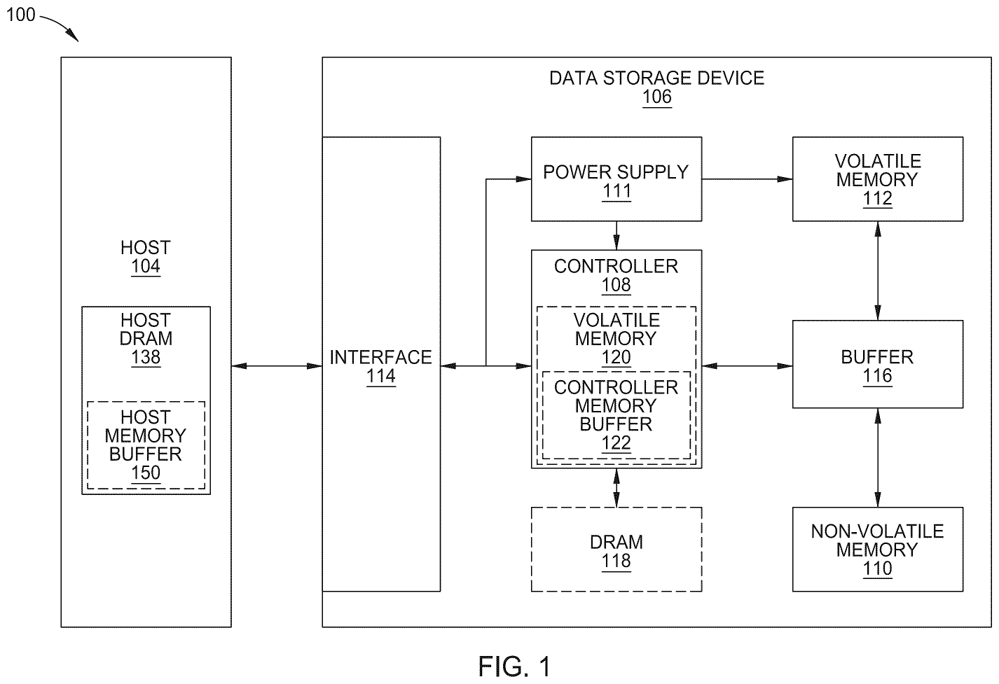

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

PCI permits turning on and off lanes without turning down the link. Imagine an example where there are two host devices. Each host device wants to have four ports. Thus, each host device is capable of supporting four lanes, but the data storage device only accommodates six lanes in total. If there are more than six lanes, the extra lanes will not help and will not improve anything. In fact, the extra lanes will cost extra and utilize more power. Therefore, for cost reasons and power reasons, only six lanes are needed.

To allocate the six lanes, four lanes can be allocated to one port and the other two lanes can be allocated to the other port, but the allocation of two of the lanes on the one port can be switched to the other port. Thus, each host device sees four lanes, but not at the same time. Each port will be able to see four lanes while the data storage device supports six lanes. The controller can dynamically determine which port needs more lanes. The need may be based upon bandwidth. The caveat for dynamically adjusting the lanes is that any adjustment needs to be based on the power of two noting that one is a power of two. Thus, there cannot be three or five lanes for one port. An arrangement can be one lane in one port and four lanes or two lanes or one lane in another port. The arrangement cannot be one lane in one port and five lanes in another port because five is not a power of two. It is to be understood that six lanes are merely an example as more lanes are contemplated based upon port size and data storage device accommodations. The point is that for each port that needs more bandwidth, the number of lanes can be dynamically increased.

As noted above, some NVMe devices are required to support two PCIe ports. The situation can happen, for example, in enterprise systems, which may lead to multiple configurations such as: Port A has 4 lanes while Port B has 2 lanes; Port A has 1 lane while Port B has 8 lanes; Port A has 4 lanes while Port B has 4 lanes; etc.

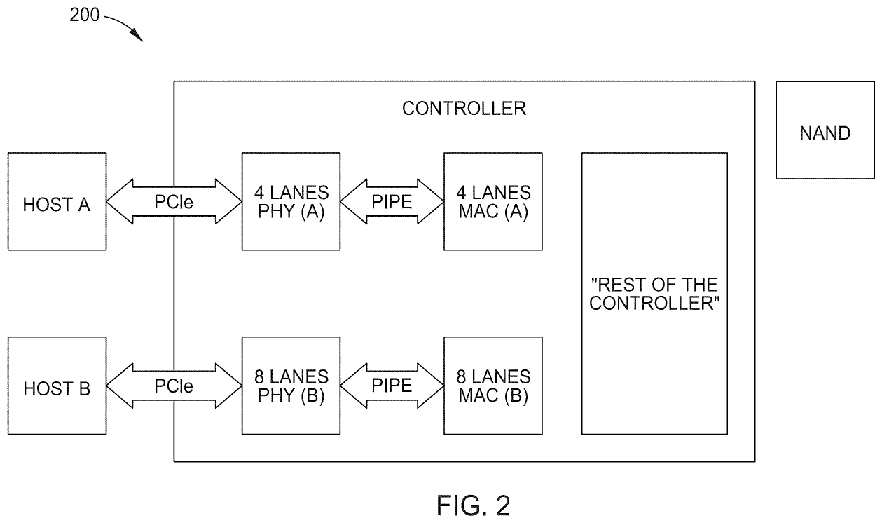

FIG. 2 is schematic illustration 200 of a twelve lane system according to one embodiment. FIG. 2 is a high-level diagram of how all of the above examples (i.e., Port A has 4 lanes while Port B has 2 lanes; Port A has 1 lane while Port B has 8 lanes; Port A has 4 lanes while Port B has 4 lanes) are supported in a single controller. As shown in FIG. 2, there are two hosts, Host A and Host B, coupled to the controller. The controller is then coupled to the memory device (e.g., NAND). The controller includes a first physical layer (PHY) coupled to Host A over a PCIe bus. The first PHY has four lanes and is coupled to a four lane memory access controller (MAC) (i.e., MAC A) through a pipeline. There are more components to the controller as shown by the label “rest of the controller”. The controller also includes a second PHY coupled to Host B over a PCIe bus. The second PHY has eight lanes and is coupled to an eight lane MAC (i.e., MAC B) through a pipeline.

The configuration in FIG. 2 allows port A to support all of the three configurations mentioned above (i.e., Port A has 4 lanes while Port B has 2 lanes; Port A has 1 lane while Port B has 8 lanes; Port A has 4 lanes while Port B has 4 lanes), and allow independently for port B to support all of the configurations. The configuration of FIG. 2 will also allow other configurations such as any (1, 2, 4 lanes) configuration for port A, and separately any configuration (1, 2, 4, 6, or 8 lanes) configuration for port B.

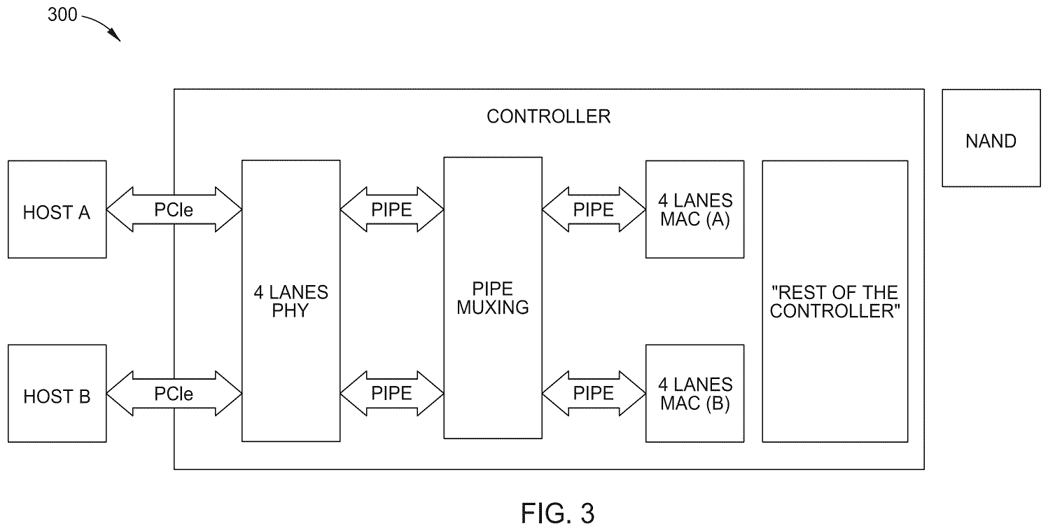

FIG. 3 provides a different setup. FIG. 3 is schematic illustration 300 of a four lane system according to one embodiment. In the configuration of FIG. 3, the PHY supports four total lanes. Stated another way, the device supports one port with four lanes or two ports each with two lanes. As shown in FIG. 3, there are two hosts, Host A and Host B, coupled to the controller. The controller is then coupled to the memory device (e.g., NAND). The controller includes a single PHY coupled to Host A and Host B over PCIe buses. The PHY has four lanes and is coupled to a pipe mixing module through piping. The pipe mixing module is coupled to a first four lane MAC (i.e., MAC A) through a pipeline and a second four lane MAC (i.e., MAC B). There are more components to the controller as shown by the label “rest of the controller”.

For a link (i.e., host device to data storage device MAC) to be able to support four lanes, the link has to enumerate with four lanes. In FIG. 3, the data storage device can either work with one link of four lanes over either MAC A or MAC B or two links of two lanes each for MAC A and MAC B. However, to switch between configurations, the data storage device needs to drop the link and re-enumerate. Starting with PCIe GEN6, each lane can be turned off and on independently, without bringing down the link.

As noted above, each lane consumes a certain amount of power, area (e.g., cost), and provides a given amount of bandwidth. Consider the following options: Configuration A: Port A has four lanes while Port B has two lanes; and Configuration B: Port A has two lanes while Port B has four lanes. While the data storage device might be able to support up to six lanes (i.e., due to power limitation), the device has two options. Option one is to hold eight lanes (i.e., four at each port) and activate only six lanes at every given time, but option one is a waste of area/cost. Option two is to hold one four lane port and one six lane port and when switching from Configuration A to Configuration B, the data storage device has to drop the link and re-connect at the new configuration, but option two is a waste of bandwidth. As will be discussed herein, the embodiments address the problem of dynamically changing bus widths to match the required bandwidth and power limitations, while saving cost.

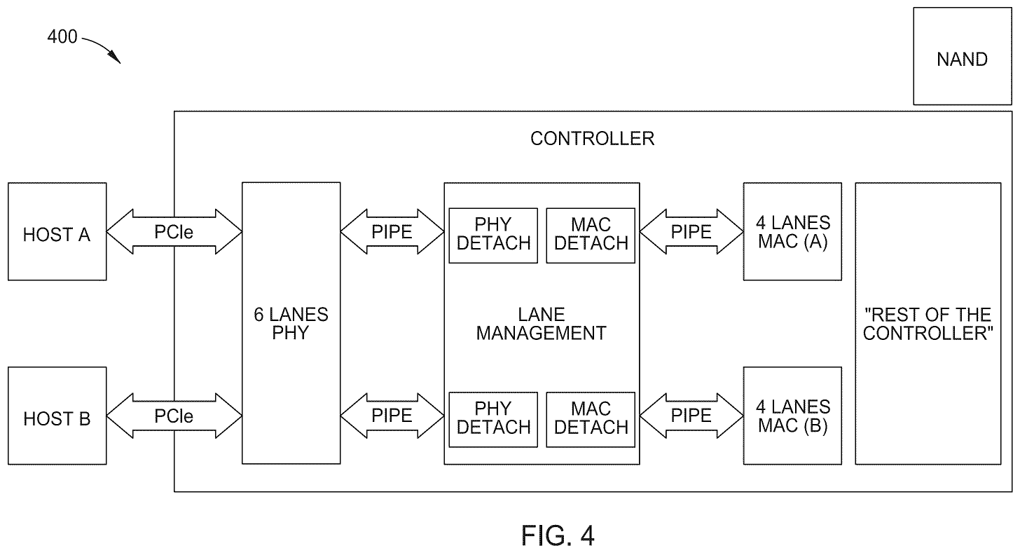

FIG. 4 focuses on changes suggested to the write handler to achieve desired results. FIG. 4 is schematic illustration 400 of a six lane system according to one embodiment. FIG. 4 shows a two host device system where Host A and Host B are coupled to the controller which in turn is coupled to the memory device (e.g., NAND). The controller has a six lane PHY that is coupled to both Host A and Host B via PCIe buses. The controller also includes a lane management module that is coupled to the six lane PHY via pipes. The lane management module includes two PHY detaches, one per host device. The lane management module also includes two MAC detaches, one per host device. Two MACs are also present, each with four lanes (e.g., MAC A and MAC B) that are each coupled to the land management module via pipes.

The lane management module's basic functionality is to connect PHY lanes to their respective MAC. As an example, the lane management module is to connect lanes 0-3 to MAC A and lanes 4 and 5 to MAC B in one embodiment. In another embodiment, the lane management module is to connect lanes 0 and 1 to MAC A and lines 2-5 to MAC B. The lane management module's enhanced functionality is to detach the lanes from the PIPE interface. The lane management module can select to provide two lanes to Port A and two lanes to Port B (i.e., A2B2, two lanes port A, and two lanes port B) as an example. Table I below illustrates the setup.

TABLE I
A2B2 Configuration

| MAC A | | | | | | |
|---|---|---|---|---|---|---|
| lanes | 0 | 1 | 2 | 3 | | |
| State | Active | Active | Detach | Detach | | |
| Mac B | | | | | | |
| lanes | | | 3 | 2 | 1 | 0 |
| State | | | Detach | Detach | Active | Active |
| PHY | | | | | | |
| lane | 0 | 1 | 2 | 3 | 4 | 5 |
| State | Active | Active | Detach | Detach | Active | Active |

In the A2B2 state, each MAC is currently using two active lanes (i.e., full operational), and each MAC is holding two lanes in the L0P state (i.e., low power). However, the MACs, instead of communicating the L0P controls to two PHY lanes, communicate to two MAC detach logic modules which allows both MACs to believe they hold two PHY lanes (each). From the MAC side, eight total lanes are seen with four lanes being active and four lanes being inactive while in reality there are only six lanes. On the PHY side, two lanes are kept in L0P by the PHY detach module because the PHY lanes cannot receive control from two different MACs.

A different example would be: Port A with 2 lanes, and Port B with 4 lanes (A2B4) configuration. Table II illustrates the configuration.

TABLE II
A2B4 Configuration

| MAC A | | | | | | |
|---|---|---|---|---|---|---|
| lanes | 0 | 1 | 2 | 3 | | |
| State | Active | Active | Detach | Detach | | |
| Mac B | | | | | | |
| lanes | | | 3 | 2 | 1 | 0 |
| State | | | Active | Active | Active | Active |
| PHY | | | | | | |
| lane | 0 | 1 | 2 | 3 | 4 | 5 |
| State | Active | Active | Active | Active | Active | Active |

In the configuration of Table II, all PHY lanes are active. MAC B uses all four lanes. MAC A is using two lanes out of four lanes while the two un-used lanes for MAC A are in fact communicating with the MAC-detach logic.

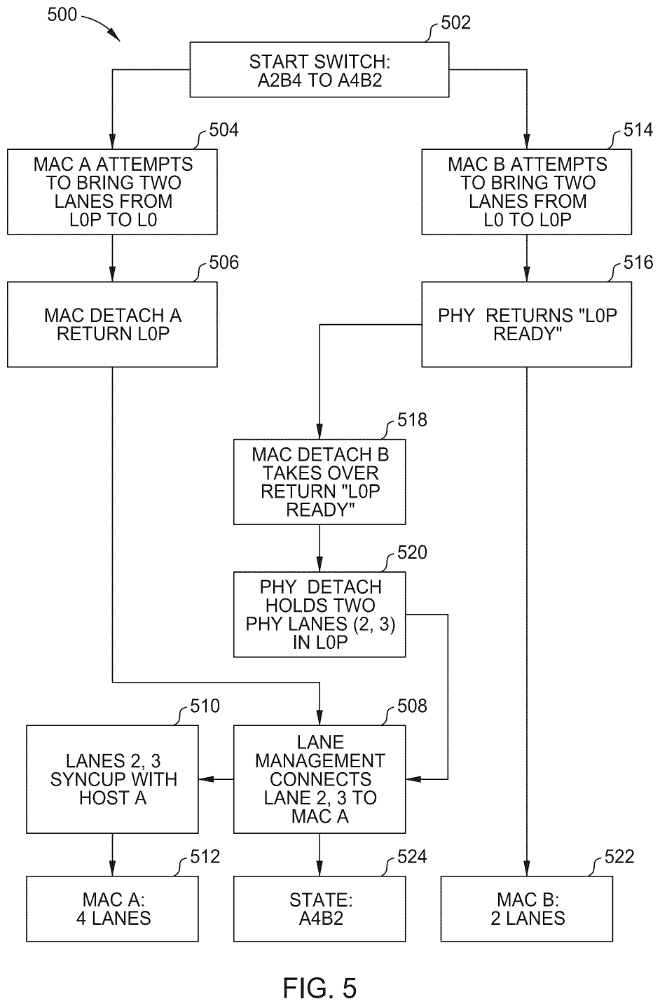

When the data storage device decides to switch between A2B4 and A4B2 configuration, the data storage device will performance the flow discussed below with regards to FIG. 5. The switching will be dynamic.

Generally speaking, two things happen in parallel. One host device (i.e., Host A) wants more bandwidth while the other host device (i.e., Host B) wants less bandwidth. In order to accommodate both Host A and Host B, switching will occur. MAC A will want to move two lanes from low power into full power, and MAC B will want to move two lanes from full power to low power. FIG. 5 discusses how to do the signaling of going into and out of L0 and L0P. Basically, MAC B detaches two lanes by moving those two lanes to low power. MAC A attaches those same two lanes by moving those two lanes into the full operational stage.

Upon detaching a lane, actions still need to occur. MAC A and MAC B are distinct. MAC A wants the maximum lanes active and MAC B wants less only two lanes active and two lanes in low power stage. When the detaching occurs, essentially, a lie is told to MAC B. The lie is that the lane is still there, but is detached. The MAC detach module takes over and informs the MAC that the two lanes that are detached are in low power stage and the MAC doesn't know that the lanes are actually detached. In the example, MAC B sees the lanes in low power stage, but in actuality the lanes are detached. The PHY detach tells the PHY that two lanes are going into low power stage. From MAC A's perspective, the added two lanes were always there, but detached. The MAC detach relinks the lanes and then moves the lanes into full operational stage.

MAC A's request to move the lanes to full operational stage can only be processed once the lanes are detached from MAC B. If the lanes are still attached to MAC B, then the MAC detach will tell MAC A to delay because there is no power to bring the lanes to full operational stage, but the reason there is no power is because the lanes are still attached to MAC B, but MAC A is unaware. After MAC B releases the two lanes and the MAC detach tells MAC B that those two lanes are in low power stage, the lane management module will change the lanes to MAC A.

Stated another way, the basic idea for the example is that there are four lanes linked to MAC B and two lanes linked to MAC A and both MAC A and MAC B want to switch for one reason or another. So first MAC B needs to say that MAC B doesn't need those two lanes and then the MAC detach module will tell MAC B that the lanes are in low power stage. Then using a connectivity matrix, the lane management module will connect those two lanes to MAC A. It is to be noted that it may take some time to release the two lanes and thus MAC A may receive a notification that the lanes are still in low power stage when in fact the lanes are detached from MAC A and still attached to MAC B.

FIG. 5 is a flowchart 500 illustrating switching from a first six lane configuration to a second six lane configuration. FIG. 5 exemplifies switching from A2B4 to A4B2. The process begins as block 502 where the switch from A2B4 to A4B2 begins. On the MAC A side, MAC A attempts to bring two lanes from L0P to L0 at block 504 and the MAC detach module A returns L0P at block 506. Simultaneously, MAC B attempts to bring two lanes from L0 to L0P at block 514. The PHY returns a message “L0P ready” at block 516 and MAC B has two fully operational lanes at block 522. Upon receiving the message, MAC detach B takes over and returns a message “L0P ready” as block 518 and the PHY detach holds two PHY lanes (2, 3) in L0P at block 520. The lane management module connects lanes 2 and 3 to MAC A at block 508 and at this point the data storage device technically is in state A4B2 at block 524. Lanes 2 and 3 then sync-up with Host A at block 510 and MAC A has four lanes at block 512.

Three threads are performed in parallel MAC A (on the left), MAC B (on the right), and the lane management in the middle. Looking at MAC B first. MAC B requests to turn off two lanes from L0 to L0P. The PHY returns “L0P ready” towards MAC B. MAC B, while not being aware of it, communicates L0P to the MAC-detach logic. MAC B is thus in two lanes mode.

Looking at MAC A second. MAC A requests to move two lanes from L0P back to L0. MAC A receives an indication from the MAC detach logic, while not aware of it, the PHY state is still L0P. MAC A is connected to four PHY lanes, which still return PHY state is still L0P. PHY lanes 2, 3 which are now connected to MAC A start their sync-up (CDR lock). Once done, MAC A is now in four lanes.

Looking at the lane management next. The lane management module's default state (i.e., state when starting the switch) is A2B4, meaning two MAC A lanes are connected to MAC detach-logic. The entry point is when PHY lanes 2 and 3 inform MAC-B they switched to L0P. Then, connect MAC B with MAC-detach logic. Then, connect PHY lanes 2 and 3 with PHY detach logic. Then connect PHY lanes 2 and 3 with MAC A. The final state is A4B2.

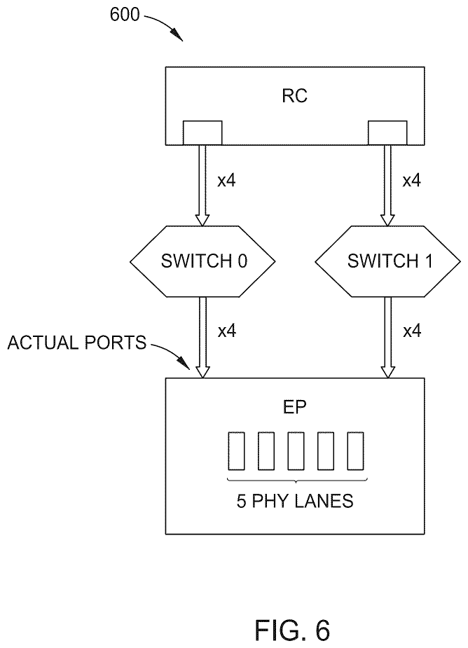

FIG. 6 is schematic illustration of a multiport system 600 according to one embodiment. In FIG. 6, the endpoint (EP) has five PHY lanes. There are two switches, Switch 0 and Switch 1, each coupled to the EP. There is one host device (RC) that may have two virtual host devices or two distinct connections through the switches to the EP. In the example, there are four lanes per virtual host device and per switch. In this example, if one switch malfunctions, there are still four lanes on the other port. For example, if Switch 0 stops working due to a malfunction, the four ports for Switch 1 can be used instead of being limited to one port. An enumeration with four lanes can be done on each port using the L0P capability. While working with four lanes on Switch 0 or with four lanes on Switch 1, it is also possible to work with four lanes plus one lanes using two ports.

By adding detach logic, both the PHY and the MAC can be tricked to hold specific lanes in L0P which allows moving lanes 2 and 3 between MAC A and MAC B without taking down the link. In turn, using only six lanes, any two port configuration can be held with a total of six lanes. Thus, multiport systems have improved efficiencies.

In one embodiment, a data storage device comprises: a memory device; and a controller coupled to the memory device, wherein the controller is configured to: request to move one or more first lanes of a first MAC from a low power state to a full operational state; request to move one or more second lanes of a second MAC from the full operational state to the low power state, wherein the second MAC is distinct from the first MAC; move the one or more second lanes of the second MAC to the low power state; and move the one or more first lanes of the first MAC to the full operational state, wherein the one or more first lanes and the one or more second lanes are the same lanes. The data storage device is configured to be coupled to a plurality of hosts, wherein controller comprises a lane management module that includes a plurality of PHY detaches and a plurality of MAC detaches. A number of PHY detaches of the plurality of PHY detaches is equal to a number of hosts of the plurality of hosts. A number of MAC detaches of the plurality of MAC detaches is equal to a number of hosts of the plurality of hosts. A number of PHY detaches of the plurality of PHY detaches is equal to a number of MAC detaches of the plurality of MAC detaches. A PHY returns a message of “L0P ready” towards the second MAC after the request to move one or more second lanes of the second MAC from the full operational state to the low power state. A MAC detach is configured to communicate “L0P ready” to a MAC, to mimic PHY behavior. The first MAC is configured to receive an indication from MAC detach logic that a PHY state is still L0P. The controller is configured to connect the one or more second lanes to the first MAC. The controller is configured to sync up the one or more second lanes with a host device.

In another embodiment, a data storage device comprises: a memory device; and a controller coupled to the memory device, wherein the controller is configured to: manage a plurality of lane connections between a plurality of MACs and a plurality of host devices, wherein one or more first lane connections of the plurality of lane connections are present for a first MAC of the plurality of MACs, wherein one or more second lane connections of the plurality of lane connections are present for a second MAC of the plurality of MACs, and wherein one or more third lanes connections of the plurality of lane connections are shared by the first MAC and the second MAC; cause the first MAC to register the one or more third lane connections as being in a low power state; and cause the second MAC to register the one or more third lane connections as being in a full operational state, wherein the first MAC registers the one or more third lane connections as being in the low power state simultaneous with the second MAC registering the one or more third lane connections as being in the full operational state. The controller is configured to virtually connect the one or more third lane connections to the second MAC. The controller is configured to virtually disconnect the one or more third lane connections from the first MAC. The controller is configured to cause the first MAC to register connection to the one or more first lane connections and the one or more third lane connections with the first MAC registering the one or more first lane connections as in the full operational state and the one or more third lane connections in the low power state. The controller is configured to cause the second MAC to register connection to the one or more second lane connections and the one or more third lane connections with the second MAC registering the one or more second lane connections and the one or more third lane connections as in the full operational state. The first MAC is coupled to a lane management module that has a corresponding first MAC detach and a PHY detach, and wherein the PHY detach is coupled to a multi-lane PHY. The lane management module is configured to detach lanes from a first interface with MAC A and to detach lanes from a second interface with MAC B.

In another embodiment, a data storage device comprises: means to store data; and a controller coupled to the means to store data, wherein the controller is configured to: maintain a PHY having a first plurality of lanes: maintain a first MAC that has a second plurality of lanes, wherein the first plurality is greater than the second plurality; maintain a second MAC that has a third plurality of lanes, wherein the first plurality is greater than the third plurality; and switch between a low power state and a full operational state for lanes shared by the first MAC and the second MAC. The first plurality is less than a sum of the second plurality and the third plurality. The switching comprises switching from a full operational state for the shared lanes to a low power state for the first MAC, wherein the switching comprises switching from the lower power state to the full operational state for the shared lanes for the second MAC.

While the foregoing is directed to embodiments of the present disclosure, other and further embodiments of the disclosure may be devised without departing from the basic scope thereof, and the scope thereof is determined by the claims that follow.

1. A data storage device, comprising:
a memory device; and
a controller coupled to the memory device, wherein the controller is configured to:
request to move one or more first lanes of a first memory access controller (MAC) from a low power state to a full operational state;
request to move one or more second lanes of a second MAC from the full operational state to the low power state, wherein the second MAC is distinct from the first MAC;
move the one or more second lanes of the second MAC to the low power state; and
move the one or more first lanes of the first MAC to the full operational state, wherein the one or more first lanes and the one or more second lanes are the same lanes.

2. The data storage device of claim 1, wherein the data storage device is configured to be coupled to a plurality of hosts, wherein controller comprises a lane management module that includes a plurality of physical layer (PHY) detaches and a plurality of MAC detaches.

3. The data storage device of claim 2, wherein a number of PHY detaches of the plurality of PHY detaches is equal to a number of hosts of the plurality of hosts.

4. The data storage device of claim 2, wherein a number of MAC detaches of the plurality of MAC detaches is equal to a number of hosts of the plurality of hosts.

5. The data storage device of claim 2, wherein a number of PHY detaches of the plurality of PHY detaches is equal to a number of MAC detaches of the plurality of MAC detaches.

6. The data storage device of claim 1, wherein a physical layer (PHY) returns a message of “L0P ready” towards the second MAC after the request to move one or more second lanes of the second MAC from the full operational state to the low power state.

7. The data storage device of claim 6, wherein a MAC detach is configured to communicate “L0P ready” to a MAC, to mimic PHY behavior.

8. The data storage device of claim 1, wherein the first MAC is configured to receive an indication from MAC detach logic that a physical layer (PHY) state is still L0P.

9. The data storage device of claim 1, wherein the controller is configured to connect the one or more second lanes to the first MAC.

10. The data storage device of claim 1, wherein the controller is configured to sync up the one or more second lanes with a host device.

11. A data storage device, comprising:
a memory device; and
a controller coupled to the memory device, wherein the controller is configured to:
manage a plurality of lane connections between a plurality of memory access controllers (MACs) and a plurality of host devices, wherein one or more first lane connections of the plurality or lane connections are present for a first MAC of the plurality of MACs, wherein one or more second lane connections of the plurality of lane connections are present for a second MAC of the plurality of MACs, and wherein one or more third lane connections of the plurality of lane connections are shared by the first MAC and the second MAC;
cause the first MAC to register the one or more third lane connections as being in a low power state; and
cause the second MAC to register the one or more third lane connections as being in a full operational state, wherein the first MAC registers the one or more third lane connections as being in the low power state simultaneous with the second MAC registering the one or more third lane connections as being in the full operational state.

12. The data storage device of claim 11, wherein the controller is configured to virtually connect the one or more third lane connections to the second MAC.

13. The data storage device of claim 12, wherein the controller is configured to virtually disconnect the one or more third lane connections from the first MAC.

14. The data storage device of claim 11, wherein the controller is configured to cause the first MAC to register connection to the one or more first lane connections and the one or more third lane connections with the first MAC registering the one or more first lane connections as in the full operational state and the one or more third lane connections in the low power state.

15. The data storage device of claim 12, wherein the controller is configured to cause the second MAC to register connection to the one or more second lane connections and the one or more third lane connections with the second MAC registering the one or more second lane connections and the one or more third lane connections as in the full operational state.

16. The data storage device of claim 11, wherein the first MAC is coupled to a lane management module that has a corresponding first MAC detach and a physical layer (PHY) detach, and wherein the PHY detach is coupled to a multi-lane PHY.

17. The data storage device of claim 16, wherein the lane management module is configured to detach lanes from a first interface with MAC A and to detach lanes from a second interface with MAC B.

18. A data storage device, comprising:
means to store data; and
a controller coupled to the means to store data, wherein the controller is configured to:
maintain a physical layer (PHY) having a first plurality of lanes:
maintain a first memory access controller (MAC) that has a second plurality of lanes, wherein the first plurality is greater than the second plurality;
maintain a second MAC that has a third plurality of lanes, wherein the first plurality is greater than the third plurality; and
switch between a low power state and a full operational state for lanes shared by the first MAC and the second MAC.

19. The data storage device of claim 18, wherein the first plurality is less than a sum of the second plurality and the third plurality.

20. The data storage device of claim 19, wherein the switching comprises switching from a full operational state for the shared lanes to a low power state for the first MAC, wherein the switching comprises switching from the lower power state to the full operational state for the shared lanes for the second MAC.
